(19) United States
(12) Patent Application Publication
(10) Pub. No.: US 2019/0058299 A1
(43) Pub. Date: Feb. 21, 2019

(54) LATERAL HORIZONTAL ELECTRICAL RECEPTACLE

(71) Applicant: Barry Lee Bryan, El Granada, CA (US)

(72) Inventor: Barry Lee Bryan, El Granada, CA (US)

(21) Appl. No.: 16/103,245

(22) Filed: Aug. 14, 2018

Related U.S. Application Data
(60) Provisional application No. 62/605,506, filed on Aug. 16, 2017.

(51) Int. Cl. H01R 25/00; H01R 13/506; H01R 27/02

(52) U.S. Cl. CPC H01R 25/006; H01R 27/02; H01R 13/506

(57) ABSTRACT

An electrical receptacle may include a housing having a width that is greater than a height in a horizontal orientation. A neutral terminal, a line terminal and a grounding terminal may be on the housing. A socket may be positioned on a front surface of the housing. The socket may include a neutral slot electrically coupled to the neutral terminal, a line slot electrically coupled to the line terminal and a grounding slot electrically coupled to the grounding terminal. The neutral slot may be positioned to the left of the line slot in the horizontal orientation, and the grounding slot may be positioned below the neutral slot and the line slot in the horizontal orientation.

### RELATED APPLICATION

This application claims the benefit under 35 U.S.C. § 119(e) of U.S. Provisional Application 62/605,506 filed on Aug. 16, 2017.

### TECHNICAL FIELD

Implementations of the disclosure relate to an electrical receptacle, and in particular, to a lateral horizontal electrical receptacle.

### BACKGROUND

An electrical receptacle includes a socket that connects an electrical device to a power supply. The electrical receptacle can be installed in a wall or floor. The socket of the electrical receptacle can include two or more slots configured to couple to an electrical plug of an electrical device.

### BRIEF DESCRIPTION OF THE DRAWINGS

The accompanying drawings, which are incorporated herein and form a part of the specification, illustrate the disclosure and, together with the description, further serve to explain the principles of the disclosure and to enable a person skilled in the pertinent art to make and use the disclosure. The disclosure is illustrated by way of examples, and not by way of limitation, in the figures of the accompanying drawings.

FIG. 1 illustrates a lateral horizontal electrical receptacle with a single socket, in accordance with embodiments of the disclosure.

FIG. 2 illustrates a lateral horizontal electrical receptacle with multiple sockets, in accordance with embodiments of the disclosure.

FIG. 3 illustrates a lateral horizontal electrical receptacle with multiple sockets and a ground fault circuit interrupter (GFI), in accordance with embodiments of the disclosure.

FIG. 4 illustrates a top down view of a lateral horizontal electrical receptacle with multiple sockets and a GFI, according to an embodiment of the disclosure.

FIG. 5 illustrates an example of a lateral horizontal electrical receptacle including a face plate positioned above the housing, according to embodiments of the disclosure.

FIG. 6 illustrates a lateral horizontal electrical receptacle with multiple sockets and Universal Serial Bus (USB) ports, according to embodiments of the disclosure.

FIG. 7 illustrates an installation of a lateral horizontal electrical receptacle with multiple sockets, in accordance with an embodiment of the disclosure.

### DETAILED DESCRIPTION

Aspects of the disclosure relate to a lateral horizontal electrical receptacle. The electrical receptacle may include a housing having a width that is greater than a height. The electrical receptacle may include one or more terminals that are electrically coupled to a power source. The electrical receptacle may further include one or more sockets configured to couple to an electrical plug of an electronic device to provide power to the electronic device. Each of the one or more sockets may include a neutral slot, a line slot and a grounding slot that are electrically connected to a neutral terminal, a line terminal and a grounding terminal of the electrical receptacle, respectively.

Conventional electrical receptacles can include a housing with one or more sockets on the front surface of the housing. The one or more sockets are positioned on the front surface of the housing such that, when the conventional electrical receptacle is mounted horizontally the neutral slot and the grounding slot are to the side (e.g., left or right side) of the grounding slot. The electrical receptacle may be mounted on a wall above a surface, such as a floor or countertop.

However, when a conventional electrical receptacle is mounted in a horizontal orientation above a surface, one of the energized slots (e.g., the neutral or line slot) of the socket is closest to the surface. This increases the possibility that the energized slot closest to the surface is exposed to moisture or liquid on the surface. For example, if a conventional electrical receptacle is mounted above a kitchen countertop, one of the energized slots may be exposed to liquid that has pooled on the surface of the kitchen countertop. This exposure of the energized slot may result in a short of the electrical receptacle or an electric shock of a user within the vicinity of the electrical receptacle.

Furthermore, the orientation of the sockets in a conventional electrical receptacle may prevent the connection of multiple electrical devices with the electrical receptacle. For example, if an electric plug for an electronic device has a large housing, then the housing of the electric plug may obscure a portion of the adjacent socket when the electric plug is plugged in to a socket of the electrical receptacle. This results in inefficient utilization of the conventional electrical receptacle since the adjacent socket of the electrical receptacle is unable to be used.

Aspects of the disclosure address the above and other deficiencies by providing a lateral horizontal electrical receptacle. The lateral horizontal electrical receptacle (also referred to as “electrical receptacle” hereafter) may include a housing having a width that is greater than a height. The lateral horizontal electrical receptacle may include one or more sockets positioned on a front surface of the housing, each having a neutral slot, a line slot and a grounding slot. When the electrical receptacle is mounted in a horizontal orientation, the one or more sockets may be positioned on the front surface of the housing such that the neutral slot and line slot of the one or more sockets are located above the grounding slot.

Thus, aspects of the disclosure may be advantageous by positioning the neutral and line slots of a socket above the grounding slot when the electrical receptacle is mounted in a horizontal orientation. By positioning the neutral and line slots of the socket above the grounding slot, the distance between the energized slots (e.g., the neutral or line slot) of the socket and a surface (e.g., floor, countertop, etc.) is increased. This decreases the probability of one of the energized slots coming into contact with moisture or liquid that may be present on the surface. This reduces the probability of an electrical short or electrical shock occurring and increases the safety of the electrical receptacle.

Furthermore, by positioning the neutral and line slots of the socket above the grounding slot, plugging in an electrical plug with a large housing into one of the sockets may not obscure an adjacent socket of the electrical receptacle. This results in a more efficient utilization of the electrical receptacle since multiple electronic devices may be plugged into the electrical receptacle. Additionally, by positioning the neutral and line slots of the socket above the grounding slot, the receptacle may be more aesthetically pleasing than a conventional electrical receptacle in a horizontal orientation since the sockets are in a perpendicular orientation relative to the surface (e.g., floor, countertop etc.)

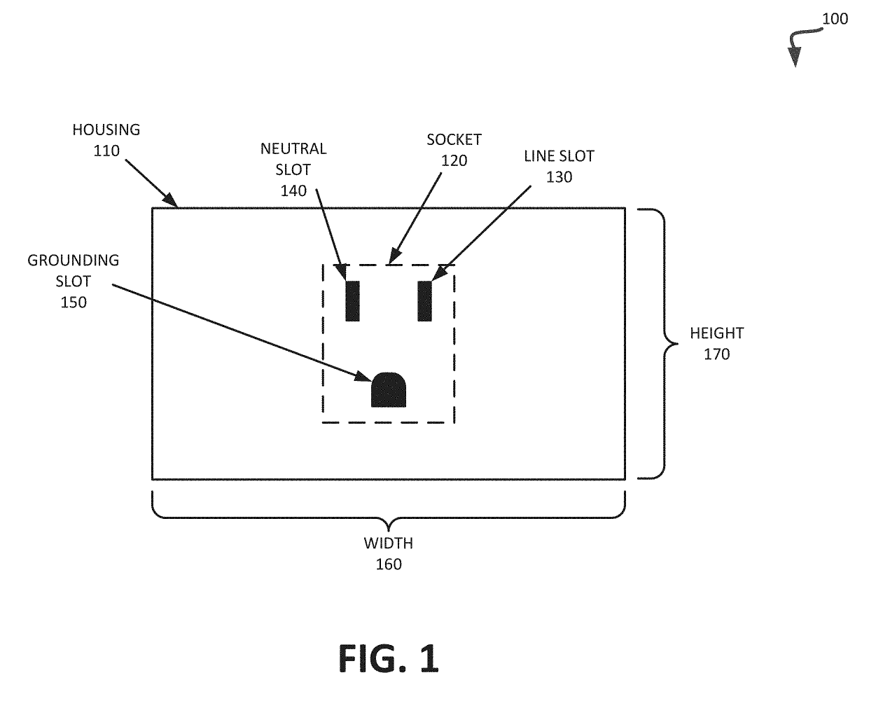

FIG. 1 illustrates a lateral horizontal electrical receptacle 100 with a single socket, in accordance with embodiments of the disclosure. The electrical receptacle 100 may include a housing 110 and a socket 120. The housing 110 may enclose at least a portion of the socket 120 as well as electrical couplings between the slots of socket 120 and electrical terminals (not shown) connected to a power supply. The housing 110 may enclose one or more conductive paths to electrically connect the electrical terminals to the corresponding slots of the socket 120. In embodiments, the housing 110 may be composed of an insulating material, such as an epoxy, plastic, glass, ceramic material, etc. In some embodiments, the housing 110 may be composed of a conductive material, such as metals, electrolytes, conductive polymers, etc. When installed in a horizontal orientation, the housing 110 may have a width 160 that is greater than a height 170 of the housing 110.

The socket 120 may be positioned on a front surface of the housing 110. The socket 120 may include a line slot 130, a neutral slot 140 and a grounding slot 150. The line slot 130, neutral slot 140 and grounding slot 150 may be electrically coupled to a line terminal, a neutral terminal and a grounding terminal (not shown) on the housing, respectively. The line terminal, neutral terminal and grounding terminal may be configured to electrically couple to a power source.

Referring to FIG. 1, the line slot 130 and neutral slot 140 of the socket 120 may be positioned above the grounding slot 150 when the electrical receptacle 100 is in a horizontal orientation. When the electrical receptacle 100 is in a horizontal orientation, the neutral slot 140 of the socket 120 may be to the left of the line slot 130 of the socket 120. The socket 120 may be configured to couple to a plug of an electrical device. In embodiments, the socket 120 may be positioned at the center of the front surface of the housing 110. In some embodiments, the socket 120 may be positioned to the left or right of the center of the front surface of the housing 110. In an embodiment, the electrical receptacle 100 may include a ground fault circuit interrupter (GFI), universal serial bus (USB) port, and/or other peripheral connection interface, as will be described in more detail below.

In embodiments, the socket 120 may be a 120-volt socket, such as a National Electrical Manufacturers Association (NEMA) 120-volt type socket. In an embodiment, the socket may be a 240-volt socket. Although embodiments of the disclosure illustrate the socket 120 as being a 3-pronged socket (e.g., having a line slot, a neutral slot and a grounding slot), embodiments of the disclosure may utilize a 2-pronged socket (e.g., having a line slot and a neutral slot) or a 4-pronged electrical outlet.

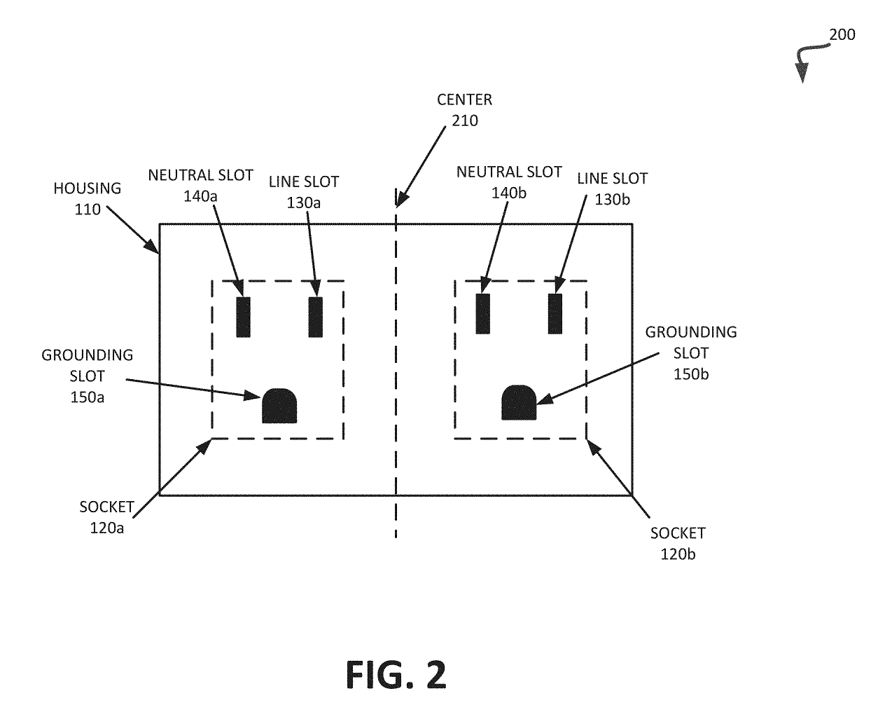

FIG. 2 illustrates a lateral horizontal electrical receptacle 200 with multiple sockets, in accordance with embodiments of the disclosure. The electrical receptacle 200 may include sockets 120a, 120b that correspond to socket 120 of FIG. 1. Socket 120a may include line slot 130a, neutral slot 140a and grounding slot 150a. Socket 120b may include line slot 130b, neutral slot 140b and grounding slot 150b. The electrical receptacle 200 may include a center 210 that corresponds to the horizontal center of the housing 110 of the electrical receptacle 200.

Referring to FIG. 2, socket 120a may be positioned on the front surface of the housing 110 at a position that is to the left of the center 210. The neutral slot 140a of socket 120a may be positioned to the left of the line slot 130a of socket 120a. The grounding slot 150a of socket 120a may be positioned below the neutral slot 140a and the line slot 130a.

Socket 120b may be positioned on the front surface of the housing 110 at a position that is right of the center 210. The neutral slot 140b of socket 120b may be positioned to the left of the line slot 130b of socket 120b. The grounding slot 150b of socket 120b may be positioned below the neutral slot 140b and the line slot 130b. Although FIG. 2 illustrates the electrical receptacle 200 as having two sockets (e.g., sockets 120a, 120b), embodiments of the disclosure may include an electrical receptacle having any number of sockets.

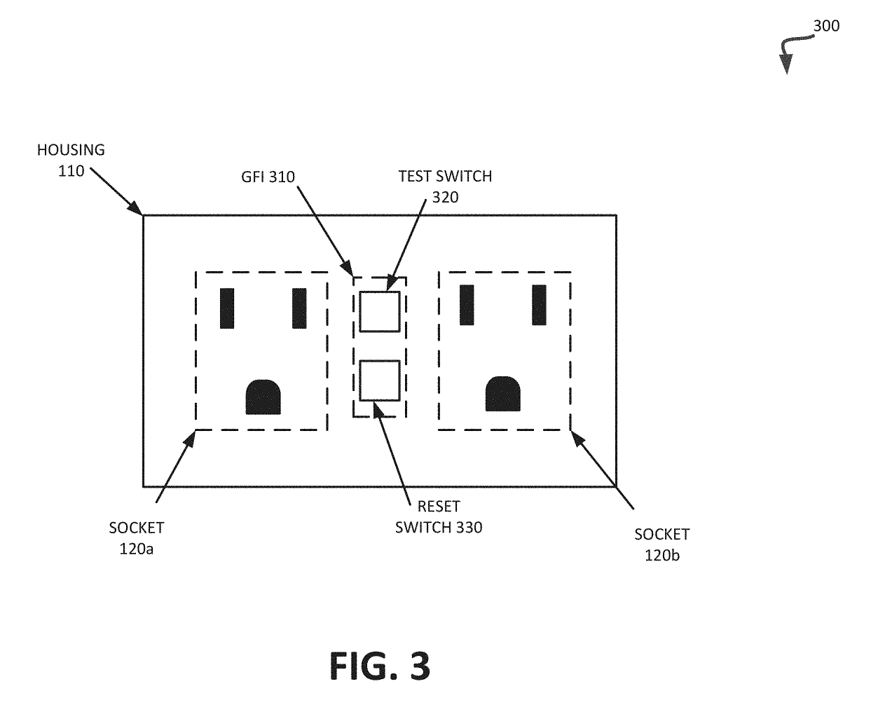

FIG. 3 illustrates a lateral horizontal electrical receptacle 300 with multiple sockets and a ground fault circuit interrupter (GFI), in accordance with embodiments of the disclosure. The electrical receptacle 300 may include sockets 120a, 120b as previously described at FIG. 2. The electrical receptacle 300 may include a GFI 310 that is configured to detect a change in current conducted by socket 120a and/or socket 120b. Upon detecting a change in current, the GFI 310 may disrupt the flow of electricity to sockets 120a and 120b.

In embodiments, the GFI 310 may include a test switch 320 and a reset switch 330 that are positioned on the front surface of the housing 110. The test switch 320 and the reset switch 330 may allow for the testing of the GFI 310 to ensure the GFI 310 is functioning properly. Depressing the test switch 320 may disconnect the flow of electricity to sockets 120a and 120b, while depressing the reset switch 330 may restore the flow of electricity to sockets 120a and 120b. Although the test switch 320 and reset switch 330 are illustrated as being positioned at the center of the front surface of the housing 110, in embodiments the test switch 320 and reset switch 330 may be positioned at any location on the front surface of the housing 110.

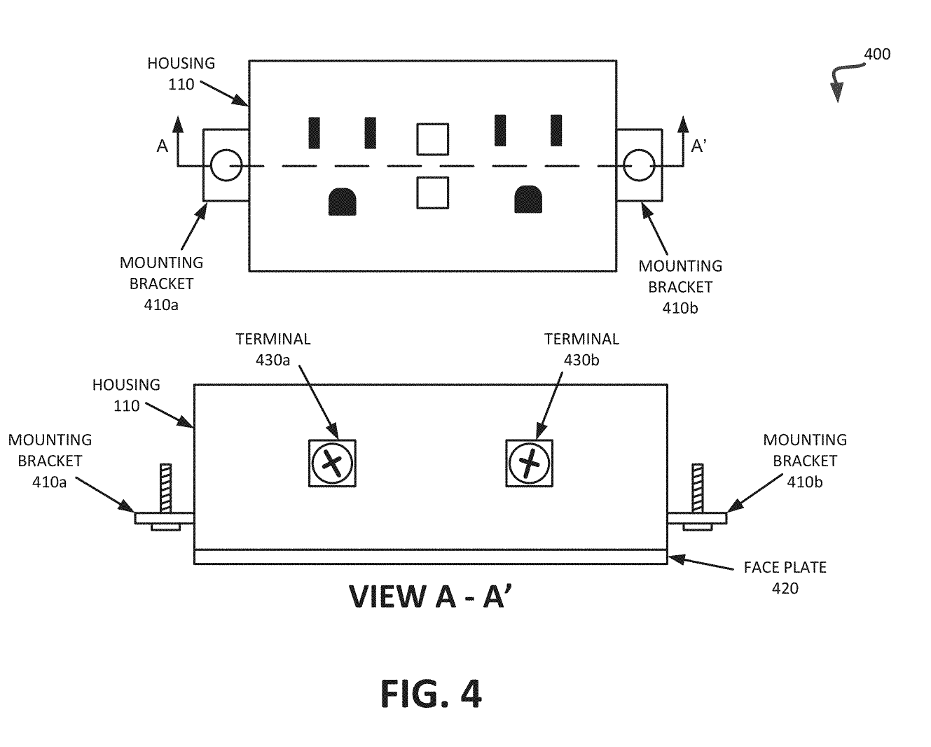

FIG. 4 illustrates a top down view of a lateral horizontal electrical receptacle 400 with multiple sockets and a GFI, according to an embodiment of the disclosure. The electrical receptacle 400 may include multiple sockets and a GFI, as previously described in FIG. 3. The electrical receptacle 400 may include mounting brackets 410a, 410b that are positioned on the sides of the housing 110 of electrical receptacle 400. The mounting brackets 410a, 410b may be configured to mount the electrical receptacle 400 to a surface, electrical box, conduit box, etc. The mounting brackets 410a, 410b may be formed from metal, plastic, ceramic or any other suitable material. In embodiments, mounting bracket 410a may be positioned on the left hand side of housing 110 and mounting bracket 410b may be positioned on the right hand side of housing 110. Although electrical receptacle 400 is illustrated as having mounting brackets 410a, 410b positioned on the sides of housing 110, in embodiments electrical receptacle 400 can include any number of mounting brackets positioned on any surface of housing 110.

Referring to FIG. 4, VIEW A-A′ illustrates a top down view of electrical receptacle 400. Terminals 430a, 430b may be positioned on the top surface of housing 110. Terminals 430a, 430b may be configured to electrically connect to a power source and the sockets of the electrical receptacle 400. For example, terminal 430a may be electrically connected to a neutral terminal from a power source and the neutral slots of the sockets of the electrical receptacle 400. Terminals 430a, 430b may be any type of electrical terminal, such as side terminal screws, push-in terminals, etc. In embodiments, additional terminals (not shown) may be positioned on the top surface or other surfaces of housing 110. Furthermore, although terminals 430a, 430b are illustrated as being positioned on the top surface of housing 110, in embodiments terminals 430a, 430b and any additional terminals may be positioned on any surface of the housing 110.

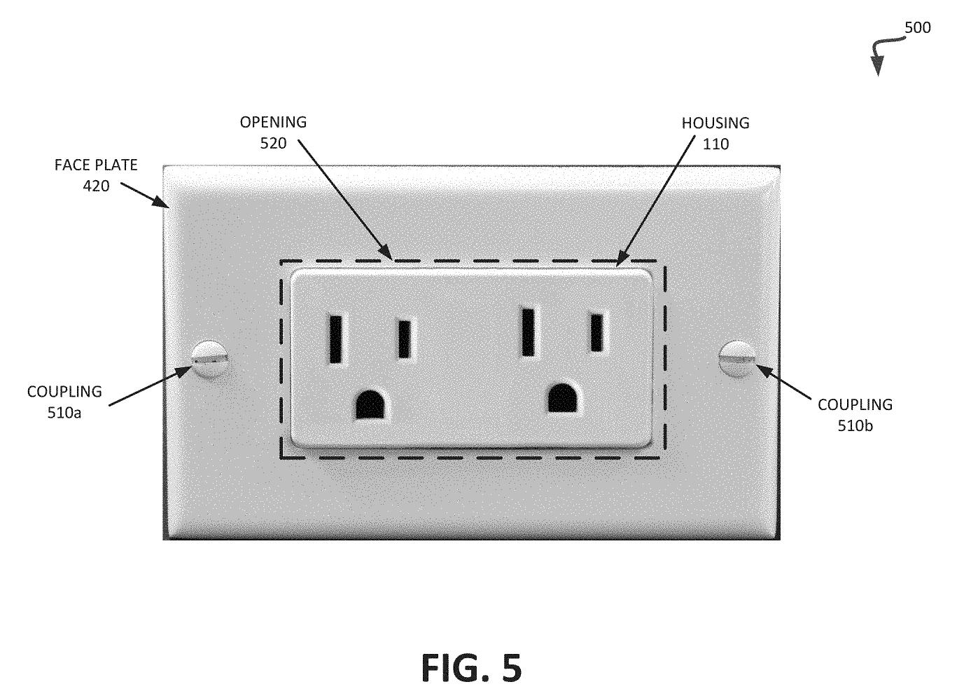

In some embodiments, the electrical receptacle 400 may include a face plate 420 positioned above the front surface of the housing 110. The face plate 420 may be formed of plastic, glass, ceramic, metal or any other suitable material. The face plate 420 may include multiple openings above the features positioned on the front surface of the housing. For example, the face plate may include openings above the line slots, neutral slots and grounding slots for sockets positioned on the front surface of the housing 110 to allow an electrical plug to be plugged into the sockets. In another example, the face plate may include one or more openings above the test and reset switches of a GFI to allow access to the test and reset switches. In embodiments, the face plate 420 may be attached to the front surface of the housing 110 using one or more couplings, such as screws, clips, adhesives, epoxies, magnets, etc. Aspects of face plate 420 will be described in more detail at FIG. 5 below.

FIG. 5 illustrates an example of a lateral horizontal electrical receptacle 500 including a face plate positioned above the housing, according to embodiments of the disclosure. As previously described, face plate 420 may be positioned above the housing 110 of the electrical receptacle 500. In embodiments, the face plate 420 may be attached to the front surface of housing 110 using couplings 510a, 510b. The face plate 420 may include an opening 520 to allow features positioned on the front surface of housing 110, such as sockets, to be accessed. In embodiments, the housing 110 may include coupling interfaces (not shown) positioned on the front surface of the housing 110 configured to couple to couplings 510a, 510b. For example, one or more threaded inserts may be positioned on the front surface of the housing 110 that are configured to couple to screws that may be used to attach face plate 420 to housing 110.

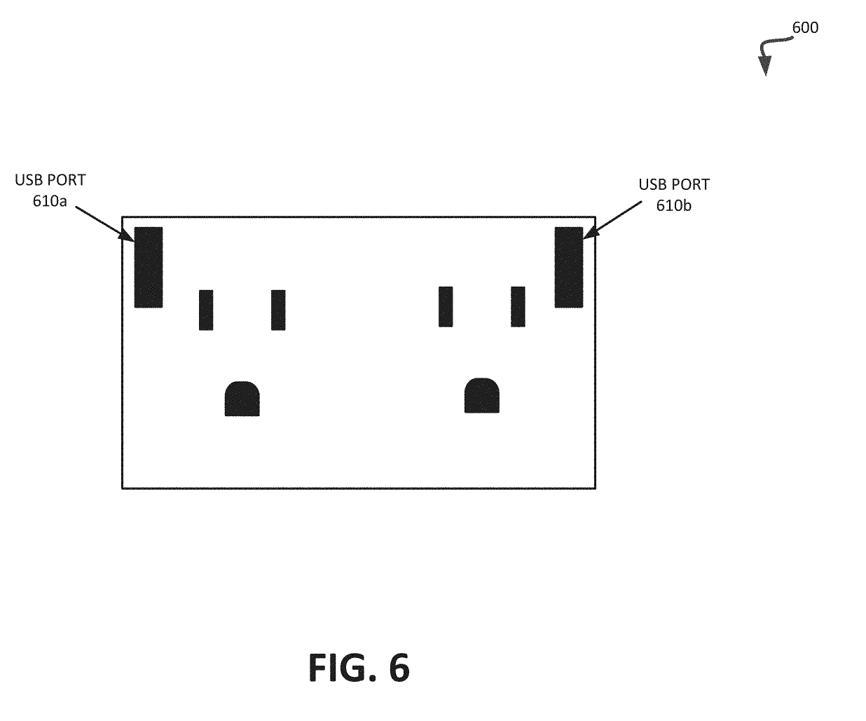

FIG. 6 illustrates a lateral horizontal electrical receptacle 600 with multiple sockets and Universal Serial Bus (USB) ports, according to embodiments of the disclosure. The electrical receptacle 600 may include two sockets, as previously described at FIG. 2. The electrical receptacle also includes USB ports 610a, 610b. The USB ports 610a, 610b may be cable connection interfaces for electronic devices. The USB ports 610a, 610b may be positioned at a periphery of a housing of the lateral horizontal electrical receptacle as shown, or elsewhere in the housing. Electronic devices may be electrically coupled to USB ports 610a, 610b via a USB cable to power and/or charge the electronic devices. For example, many cellular phones include a USB cable that can be used to power and/or charge the cellular phone. USB ports 610a, 610b may be any type of USB port, such as USB Type A, USB Type B, USB Mini B, USB Micro B, USB 3.0, etc. In embodiments, electrical receptacle 600 may include other types of peripheral connection interfaces, such as FireWire, Ethernet, Serial Advanced Technology Attachment (SATA), etc. Although electrical receptacle 600 is illustrated as including two USB ports (e.g., USB ports 610a, 610b), in embodiments electrical receptacle 600 may include any number of USB ports and/or other peripheral connection interfaces.

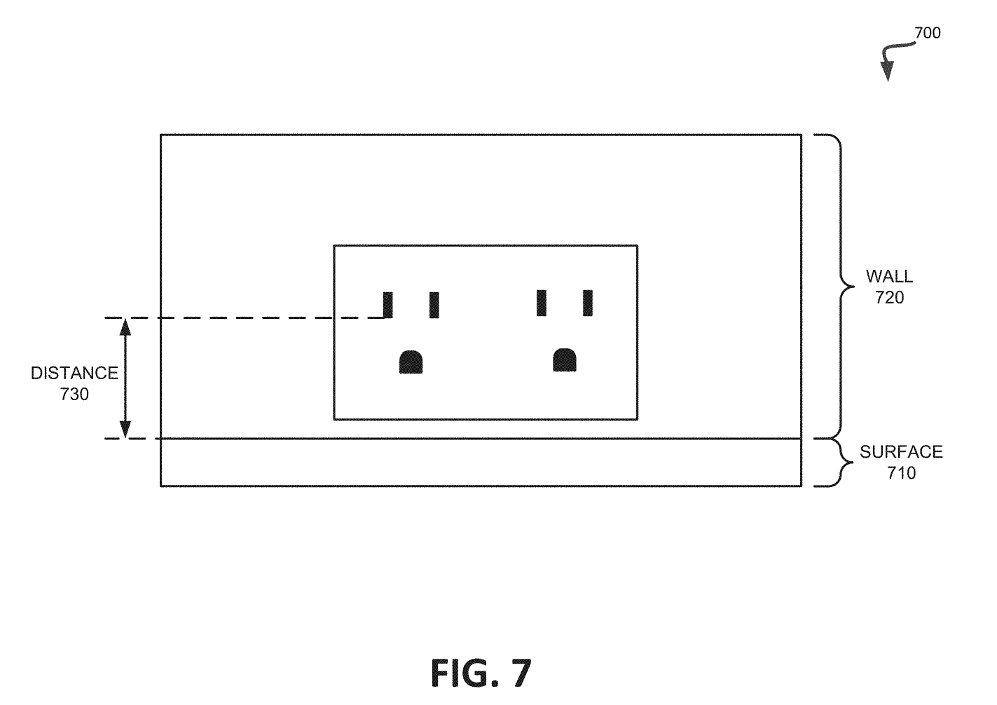

FIG. 7 illustrates an installation of a lateral horizontal electrical receptacle 700 with multiple sockets, in accordance with an embodiment of the disclosure. As previously discussed, the electrical receptacle 700 may be installed on a wall 720 that is above a surface 710. For example, the electrical receptacle 700 may be installed on a wall 720 above a kitchen or bathroom countertop.

By positioning the sockets of the electrical receptacle 700 such that the grounding slot is below the line and neutral slots when the electrical receptacle 700 is mounted in a horizontal orientation, the distance 730 between the surface 710 and the energized slots (e.g., the line and neutral slots) of the socket is increased. The increase in distance 730 between the surface 710 and the energized slots minimizes the risk of moisture or liquid on the surface 710 coming into contact with one of the energized slots of the socket. By minimizing the risk of the energized slots coming into contact with moister or liquid on surface 710, the chance of an electrical short or electric shot is reduced. Thus, the safety and performance of the electrical receptacle 700 is improved.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

The above description is intended to be illustrative and not restrictive. For example, the above-described examples (or one or more aspects thereof) may be used in combination with each other. Other implementations can be used, such as by one of ordinary skill in the art upon reviewing the above description. The abstract is provided to comply with 37 CFR 1.72(b) to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed implementation. Thus, the following claims are hereby incorporated into the Detailed Description, with each claim standing on its own as a separate implementation, and it is contemplated that such implementations can be combined with each other in various combinations or permutations. The scope of the implementations of the disclosure should be determined with reference to the appended claims, along with the full scope of equivalents to which such claims are entitled.

In the drawings, which are not necessarily drawn to scale, like numerals may describe similar components in different views. Like numerals having different letter suffixes may represent different instances of similar components. The drawings illustrate generally, by way of example, but not by way of limitation, various implementations discussed in the present document.

What is claimed is:

1. A duplex electrical receptacle comprising:
a housing having a width that is greater than a height in a horizontal orientation;
a plurality of terminals on the housing, the plurality of terminals comprising a neutral terminal, a line terminal and a grounding terminal;
a first socket positioned left of center on a front surface of the housing, the first socket comprising a first neutral slot electrically coupled to the neutral terminal, a first line slot electrically coupled to the line terminal and a first grounding slot electrically coupled to the grounding terminal, wherein the first neutral slot is positioned to the left of the first line slot in the horizontal orientation, and wherein the first grounding slot is positioned below the first neutral slot and the first line slot in the horizontal orientation; and
a second socket positioned right of center on the front surface of the housing, the second socket comprising a second neutral slot electrically coupled to the neutral terminal, a second line slot electrically coupled to the line terminal and a second grounding slot electrically coupled to the grounding terminal, wherein the second neutral slot is positioned to the left of the second line slot in the horizontal orientation, and wherein the second grounding slot is positioned below the second neutral slot and the second line slot in the horizontal orientation.

2. The electrical receptacle of claim 1, further comprising:
a universal serial bus (USB) port positioned on the front surface of the housing.

3. The electrical receptacle of claim 1, further comprising:
a ground fault circuit interrupter (GFI) configured to detect a change in current conducted by the first socket and the second socket.

4. The electrical receptacle of claim 3, wherein the GFI comprises a test switch and a reset switch.

5. The electrical receptacle of claim 1, wherein at least one of the first socket or the second socket comprises a 120-volt electrical outlet.

6. The electrical receptacle of claim 1, wherein at least one of the first socket or the second socket comprises a 240-volt electrical outlet.

7. The electrical receptacle of claim 1, wherein the plurality of terminals are positioned on at least one of a top surface or a bottom surface of the housing.

8. The electrical receptacle of claim 1, further comprising:
a first mounting bracket coupled to a left hand surface of the housing; and
a second mounting bracket coupled to a right hand surface of the housing.

9. An electrical receptacle comprising:
a housing having a width that is greater than a height in a horizontal orientation;
a plurality of terminals on the housing, the plurality of terminals comprising a neutral terminal, a line terminal and a grounding terminal;
a socket positioned on a front surface of the housing, the socket comprising a neutral slot electrically coupled to the neutral terminal, a line slot electrically coupled to the line terminal and a grounding slot electrically coupled to the grounding terminal, wherein the neutral slot is positioned to the left of the line slot in the horizontal orientation, and wherein the grounding slot is positioned below the neutral slot and the line slot in the horizontal orientation; and
a ground fault circuit interrupter (GFI) configured to detect a change in current conducted by the socket.

10. The electrical receptacle of claim 9, wherein the GFI comprises a test switch and a reset switch.

11. The electrical receptacle of claim 9, further comprising:
a universal serial bus (USB) port positioned on the front surface of the housing.

12. The electrical receptacle of claim 9, further comprising:
a face plate above the front surface of the housing, the face plate comprising a plurality of openings positioned above the neutral slot, the line slot and the grounding slot of the socket.

13. The electrical receptacle of claim 9, wherein the socket comprises a 120-volt electrical outlet.

14. The electrical receptacle of claim 9, wherein the socket comprises a 240-volt electrical outlet.

15. The electrical receptacle of claim 9, wherein the plurality of terminals are positioned on at least one of a top surface or a bottom surface of the housing.

16. The electrical receptacle of claim 9, further comprising:
a first mounting bracket coupled to a left hand surface of the housing; and
a second mounting bracket coupled to a right hand surface of the housing.
